(19) United States
(12) Patent Application Publication
(10) Pub. No.: US 2004/0131793 A1
(43) Pub. Date: Jul. 8, 2004

(54) Process for producing a scratch-resistant multilayered article

(76) Inventors: Peter Bier, Krefeld (DE); Peter Capellen, Krefeld (DE)

Correspondence Address: BAYER POLYMERS LLC, 100 BAYER ROAD, PITTSBURGH, PA, 15205, US

(21) Appl. No.: 10/673,960

(22) Filed: Sep. 29, 2003

(30) Foreign Application Priority Data
Oct. 1, 2002 (DE) 10245726.3

(51) Int. Cl. B05D 3/08; B05D 3/02; B05D 1/36

(52) U.S. Cl. 427/535; 427/387; 427/223; 427/402

(57) ABSTRACT

Disclosed is a process for preparing a multilayered coated article that includes in sequence, a substrate (S), a surface treated silane based scratch-resistant layer (R), and a silane based topcoat layer (T). The scratch-resistant layer (R) is formed by applying a scratch-resistant coating composition onto the substrate, and at least partially curing the applied scratch-resistant coating composition. The scratch-resistant coating composition comprises a polycondensate prepared by a sol-gel process from at least one silane. The surface of the scratch-resistant layer is treated by flame, corona and/or plasma treatment. The topcoat layer is formed by applying a topcoat coating composition to the surface-treated scratch-resistant layer, and curing the applied topcoat coating composition.

### CROSS REFERENCE TO RELATED PATENT APPLICATION

The present patent application claims the right of priority under 35 U.S.C. §119 (a)-(d) of German Patent Application No. 102 45 726.3, filed Oct. 1, 2002.

### FIELD OF THE INVENTION

The present invention concerns a process for producing a coating system containing a substrate (S), a scratch-resistant layer (R) and a topcoat (T) together with coating systems produced by the process.

### BACKGROUND OF THE INVENTION

Inorganic/organic hybrid materials may be produced with the aid of the sol-gel process by selective hydrolysis and condensation of alkoxides, primarily silicon, aluminium, titanium and zirconium.

An inorganic network is constructed by this process. Using appropriately derivatised silicic acid esters, organic groups may also be incorporated which may be used on the one hand for functional enhancement and on the other for the formation of defined organic polymer systems. By reason of the large number of possible combinations of both organic and inorganic components and the ability to exert an enormous influence on the product properties through the production process, this material system offers a huge breadth of variation. In particular, coating systems may be obtained in this way and tailored to a wide variety of requirement profiles.

In comparison to pure inorganic materials, the coatings obtained are still relatively soft. This is because although the inorganic components in the system have a highly crosslinking action, their very small size means that mechanical properties such as e.g. hardness and abrasion resistance are not brought to bear. Full use may be made of the favourable mechanical properties of the inorganic components using so-called filled polymers, since they have particle sizes of several micrometers. However, the transparency of the materials is then lost, and applications in the optical sector are no longer possible. Although it is possible to use small particles in the nanometer scale consisting of SiO₂ (e.g. Aerosils®), silica sol, Al₂O₃, boehmite, zirconium dioxide, titanium dioxide, etc. to produce transparent coatings with increased abrasion resistance, in the low concentrations that may be used the abrasion resistance values that are achievable are similar to those of the aforementioned systems, however. The upper limit of the amount of filler is determined by the high surface reactivity of the small particles, which leads to agglomerations or to intolerable increases in viscosity.

Substrates having an abrasion-resistant diffusion barrier coat system are known from DE 199 52 040 A1, the diffusion barrier coat system comprising a hard base coat based on hydrolysable epoxysilanes and a topcoat positioned on top of it. The topcoat is obtained by application of a coating sol consisting of tetraethoxysilane (TEOS) and glycidyloxypropyl trimethoxysilane (GPTS) and curing thereof at a temperature <110° C. The coating sol is produced by prehydrolysing TEOS with ethanol as solvent in HCl-acidic aqueous solution followed by condensation. GPTS is then stirred into the prehydrolysed TEOS and the sol stirred for 5 hours at 50° C. The disadvantage of the coating sol described in this publication is its poor storage stability (pot life), as a result of which the coating sol must be processed further within a few days of being produced. Another disadvantage of the diffusion barrier coat systems described in this publication is that according to the Taber abrasion test they display unsatisfactory results for use in automotive glazing. A final disadvantage from a manufacturing economics perspective is that adhesion between the base coat and the topcoat is only guaranteed if the topcoat is applied and cured immediately, i.e. within a few hours, after curing of the base coat. There is no possibility of separating the topcoating process from the base coat application. Instead, substrates coated with the base coat have to be processed further at once and not, as would often be desirable in terms of process economics, first stored temporarily and only coated with the topcoat when required.

A plasma coating process is known from U.S. Pat. No. 4,842,941 in which a siloxane coating is applied to a substrate, the substrate coated in this way is introduced into a vacuum chamber and the surface of the coated substrate activated in vacuo with oxygen plasma. Activation is followed by a dry chemical or physical topcoating with a silane under high vacuum by the CVD (Chemical Vapour Deposition) or PECVD (Physical Enhanced Chemical Vapour Deposition) process. A highly scratch-resistant coating is formed on the substrate in this way. The disadvantages of the dry chemical or physical topcoating processes described here are the high investment costs needed for a plasma coating plant and the complex technical measures for generating and maintaining the vacuum. Furthermore, the plasma coating process described is only of limited suitability for coating large-format three-dimensional bodies.

### SUMMARY OF THE INVENTION

The object of the present invention is to provide a process for producing a scratch-resistant coating system comprising a substrate (S), a scratch-resistant layer (R) and a highly scratch-resistant topcoat (T), which ensures optimum adhesion properties between the scratch-resistant layer (R) and the topcoat (T) and is also suitable for the uniform coating of three-dimensional substrates (S), in particular of car windscreens. The process should also allow production of the scratch-resistant layer (R) and the topcoat (T) to be separated and guarantee that once produced, a scratch-resistant layer (R) may still be coated with the topcoat (T) perfectly and without problem even after being stored for several weeks or months.

The process should also provide a coating having still further improved scratch resistance, adhesion, coating viscosity and elasticity, which in comparison to the compositions of the prior art displays a lower tendency towards gelling and haze.

In accordance with the present invention, there is provided a process for preparing a multilayered coated article comprising:

(a) providing a substrate (S);

(b) forming a scratch-resistant layer (R) having a surface, by applying a scratch-resistant coating composition onto said substrate, and at least partially curing (partially curing such that the scratch-resistant layer contains reactive groups, or fully curing the scratch-resistant layer such that it is substantially free of reactive groups) the applied scratch-resistant coating composition, said scratch-resistant coating composition comprising a polycondensate prepared from at least one silane, said polycondensate being prepared by a sol-gel process;

(c) treating the surface of the scratch-resistant layer (R) by at least one of flame treatment, corona treatment and plasma treatment, thereby forming a surface-treated scratch-resistant layer; and

(d) forming a topcoat layer by applying a topcoat coating composition onto the surface-treated scratch-resistant layer, and curing the applied topcoat coating composition, said topcoat coating composition comprising a solvent and at least one silane,

wherein said scratch-resistant layer is interposed between said substrate and said topcoat layer.

Unless otherwise indicated, all numbers or expressions, such as those expressing quantities of ingredients, reaction conditions and so forth used in the specification and claims are understood as modified in all instances by the term “about.”

### DETAILED DESCRIPTION OF THE INVENTION

Surprisingly it was found that as a result of the surface treatment in step (b) of the process according to the invention a considerably improved abrasion resistance (Taber values) is achieved in the scratch-resistant coating system. It was also surprising that thanks to the surface treatment provided in step (b) the application of the topcoat (T) may easily be separated from the application of the scratch-resistant layer (R), resulting in substantial process economic advantages in the production of the coating systems. Thus the coating systems may first be stored temporarily following application of the scratch-resistant layer (R) and only subsequently first surface treated at any time according to step (b) and then coated with the topcoat (T). The production process according to the invention is also simple and inexpensive to perform.

One of the special features of the process according to the invention lies in the fact that before application of the topcoat (T), a surface treatment of the at least partially cured scratch-resistant layer (R) is performed by flame treatment, corona treatment and/or plasma activation.

Such surface treatment processes are generally known from surface coating technology and are used for example in the coating, printing and bonding of surfaces, in particular plastic surfaces, with printing inks, adhesives, etc. The surface treatment alters the surface characteristics of the material and increases its wettability without altering the material properties.

It has now been found that such surface treatment systems may be used extremely advantageously in the topcoating of siloxane scratch-resistant layers (R) with highly scratch-resistant, diffusion-blocking siloxane topcoats (T).

The surface treatment increases the adhesion energy of the scratch-resistant layer (R). Particularly good results may be obtained if the adhesion energy of the scratch-resistant layer is increased by surface treatment to values >70 mJ/m², in particular >80 mJ/m².

It is also advantageous if the surface treatment is performed after the scratch-resistant layer (R) has been completely cured.

According to a first embodiment of the invention the surface treatment in step (b) is performed by flame treatment.

In flame treatment the oxidising part of an open flame acts upon the surface of the siloxane scratch-resistant layer (R). An exposure time of around 0.2 s, depending on the shape and mass of the moulded part to be activated, is often sufficient. Too small a quantity of heat prevents adequate surface activation, whilst too long an exposure time may deform or even melt the plastic. Flame treatment is substantially influenced by three parameters: flame setting (gas/air ratio), length of exposure to the flame and distance of the flame from the plastic (flame zone). The geometry of the flame is determined by the type of burner.

It has proven to be particularly advantageous if the flame treatment is performed in a continuous flame treatment plant at a throughput rate of 1 to 20 m/min, in particular 2 to 10 m/min.

According to a second embodiment of the invention the surface treatment in step (b) is performed by corona treatment.

In conventional (direct) corona systems, the part to be treated is introduced directly into the discharge gap of a corona discharge. In the treatment of films the gap is formed by the treatment roll, which guides the web, and a treatment electrode, which is approximately 1.5 to 2.0 mm above the roll. If the electrode is further away, a raised electrical voltage has to be applied to ignite the discharge, such that the energy content of the individual discharge increases and increasingly hot arc discharges form.

For a mild film treatment, however, it is vital that these arcs be avoided.

Typical power densities for these conventional electrodes are around 1 W/mm for a single electrode rod.

In indirect corona systems the electrical discharge occurs ahead of the workpiece. An air stream directs the discharge sparks onto the workpiece to be treated, such that only indirect contact occurs with the discharge. One principle of indirect corona treatment involves allowing the discharge to burn between two metal pin electrodes. The current limitation that is needed to form a corona discharge occurs electronically. The discharge sparks are deflected with air. Treatment distances ranging from 5 to 20 mm are achieved here. Due to this large discharge distance it is vital to minimise the energy content of the individual discharges using design measures.

By means of high operating frequencies of around 50 kHz and optimised discharge geometry and air control, the discharge intensity may be reduced to 100 W, e.g. CKG corona gun from Tigris. Single electrodes with an effective width of around 20 mm are used here.

Even complicated geometries may be treated by combining multiple electrodes. The arrangement may be adjusted to 3-dimensional parts.

Pretreatment takes place with cold corona discharges so that the surfaces of heat-sensitive plastics undergo no optical changes. Streaks and clouds do not occur.

Various corona techniques are available for the pretreatment of three-dimensional products, such as low-frequency (LF) systems, high-frequency (HF) systems and spot generators, which may be used according to the individual product.

Spot generators produce a high-voltage discharge, which is pressed onto the substrate by air, without the use of a counterelectrode. A spot generator may easily be integrated into existing production lines, is easy to use and includes a timer and alarm function. The pretreatment width is 45 to 65 mm, allowing a wide variety of products to be pretreated. The spot generator may also be supplied with two or more discharge heads.

In high-frequency corona a high-voltage discharge with a frequency of 20 to 30 kHz is generated, which forms a corona field between two electrodes in air. This corona activates the surface and so produces greater adhesion and wettability. Corona activation of sheets and simple 3D geometries is possible at high speeds.

A corona tunnel (e.g. Tantec), with which the entire surface of a body may be pretreated in the production line, is suitable for the pretreatment of complex moulded parts. The special design of the electrodes means that an absolutely homogeneous surface energy is achieved. Vertical side walls and 90° angles may also be treated. The corona tunnel design is product-specific, and it may also be integrated into existing plants. For example, it allows a non-contact pretreatment of the entire top side of parts measuring up to 100 mm high and 2000 mm wide.

The corona treatment is preferably performed in a continuous corona plant at a throughput rate of 1 to 20 m/min, in particular 2 to 10 m/min, and/or at a power of 500 to 4000 W, in particular 1500 to 3500 W.

According to a third embodiment of the invention the surface treatment in step (b) is performed by plasma activation. The plasma treatment is preferably performed in a chamber under a pressure of 1 to 10⁻² mbar, in particular 10⁻¹ to 10⁻² mbar, and at a power of 200 to 4000 W, in particular 1500 to 3500 W, with a low-frequency generator and in particular air as the process gas (e.g. BPA 2000 Standard System from Balzers).

Production of the Scratch-Resistant Layer (R)

The scratch-resistant layer (R) is produced in step (a) by application of a coating compound onto a substrate (S), the coating compound comprising a polycondensate based on at least one silane and produced by the sol-gel process, and at least partial curing thereof. The production of such scratch-resistant layers (R) on a substrate (S) is known in principle to the person skilled in the art.

There is no restriction on the choice of substrate materials (S) to be coated. The compositions are preferably suitable for the coating of wood, textiles, paper, stoneware, metals, glass, ceramics and plastics and in particular for the coating of thermoplastics as described in Becker/Braun, Kunststofftaschenbuch, Carl Hanser Verlag, Munich, Vienna 1992. The compositions are most particularly suitable for the coating of transparent thermoplastics and preferably polycarbonates. In particular, spectacle lenses, optical lenses, car windscreens and sheets may be coated with the compositions obtained according to the invention.

The scratch-resistant layer (R) is preferably formed in a thickness of 0.5 to 30 μm. A primer coat (P) may additionally be formed between the substrate (S) and the scratch-resistant layer (R).

Any silane-based polycondensates produced by the sol-gel process are suitable as coating compounds for the scratch-resistant layer (R). Particularly suitable coating compounds for the scratch-resistant layer (R) are in particular

(1) methyl silane systems,

(2) silica sol-modified methyl silane systems,

(3) silica sol-modified silyl acrylate systems,

(4) silyl acrylate systems modified with other nanoparticles (in particular boehmite),

(5) cyclic organosiloxane systems and

(6) nanoparticle-modified epoxysilane systems.

The aforementioned coating compounds for the scratch-resistant layer (R) are described in more detail below:

(1) Methyl Silane Systems

Known polycondensates based on methyl silane, for example, may be used as coating compounds for the scratch-resistant layer (R). Polycondensates based on methyl trialkoxysilanes are preferably used. The substrate (S) may be coated by for example applying a mixture of at least one methyl trialkoxysilane, a hydrous organic solvent and an acid, evaporating the solvent and curing the silane under the influence of heat to form a highly crosslinked polysiloxane. The methyl trialkoxysilane solution preferably consists of 60 to 80 wt. % silane. Particularly suitable are methyl trialkoxysilanes that hydrolyse rapidly, which is especially the case if the alkoxy group contains no more than four carbon atoms. Suitable catalysts for the condensation reaction of the silanol groups formed by hydrolysis of the alkoxy groups of the methyl trialkoxysilane are in particular strong inorganic acids such as sulfuric acid and perchloric acid. The concentration of the acid catalyst is preferably around 0.15 wt. %, relative to silane. Alcohols such as methanol, ethanol and isopropanol or ether alcohols such as ethyl glycol are particularly suitable as inorganic solvents for the system consisting of methyl trialkoxysilane, water and acid. The mixture preferably contains 0.5 to 1 mol of water per mol of silane. The production, application and curing of such coating compounds are known to the person skilled in the art and are described for example in the publications DE-OS 2136001, DE-OS 2113734 and U.S. Pat. No. 3,707,397.

(2) Silica Sol-Modified Methyl Silane Systems

Polycondensates based on methyl silane and silica sol may also be used as coating compounds for the scratch-resistant layer (R). Particularly suitable coating compounds of this type are polycondensates produced by the sol-gel process and comprising substantially 10 to 70 wt. % of silica sol and 30 to 90 wt. % of a partially condensed organoalkoxysilane in an aqueous/organic solvent blend. Particularly suitable coating compounds are the heat-curable, primer-free, unplasticised silicon coating compositions described in the publication U.S. Pat. No. 5,503,935, which relative to the weight comprise:

(A) 100 parts of resin solids in the form of a silicon dispersion in aqueous/organic solvents with 10 to 50 wt. % solids and consisting substantially of 10 to 70 wt. % of colloidal silicon dioxide and 30 to 90 wt. % of a partial condensate of an organoalkoxysilane and

(B) 1 to 15 parts of an adhesion promoter, selected from

(i) an acrylated polyurethane adhesion promoter having a \overline{M}ₙ of 400 to 1500 and selected from an acrylated polyurethane and a methacrylated polyurethane and

(ii) an acrylic polymer having reactive or interactive sites and a \overline{M}ₙ of at least 1000.

Organoalkoxysilanes that may be used to produce the dispersion of heat-curable, primer-free, unplasticised silicon coating compositions in aqueous/organic solvents preferably come under the formula

(R)ₐSi(OR¹)₄₋ₐ,

wherein R is a monovalent C₁₋₆ hydrocarbon radical, in particular a C₁₋₄ alkyl radical, R¹ is an R or a hydrogen radical and a is a whole number from 0 to 2 inclusive. The organoalkoxysilane having the above formula is preferably methyl trimethoxysilane, methyl trihydroxysilane or a mixture thereof, which may form a partial condensate.

The production, properties and curing of such heat-curable, primer-free, unplasticised silicon coating compositions are known to the person skilled in the art and described in detail for example in the publication U.S. Pat. No. 5,503,935, reference to the content of which is expressly made here.

Polycondensates based on methyl silanes and silica sol having a solids content of 10 to 50 wt. % dispersed in a water/alcohol mixture may also be used as coating compounds for the scratch-resistant layer (R). The solids dispersed in the mixture include silica sol, particularly in a quantity of 10 to 70 wt. %, and a partial condensate derived from organotrialkoxysilanes, preferably in a quantity of 30 to 90 wt. %, the partial condensate preferably having the formula R′Si(OR)₃, wherein R′ is selected from the group consisting of alkyl radicals having 1 to 3 carbon atoms and aryl radicals having 6 to 13 carbon atoms, and R is selected from the group consisting of alkyl radicals having 1 to 8 carbon atoms and aryl radicals having 6 to 20 carbon atoms. The coating composition preferably displays an alkaline pH, in particular a pH of 7.1 to around 7.8, which may be achieved by a base that is volatile at the curing temperature of the coating compound. The production, properties and curing of such coating compounds are known in principle to the person skilled in the art and are described for example in the publication U.S. Pat. No. 4,624,870.

The aforementioned coating compounds described in the publication U.S. Pat. No. 4,624,870 are mostly used in combination with a suitable primer, the primer forming an interlayer between the substrate (S) and the scratch-resistant layer (R). Suitable primer compositions are for example polyacrylate primers. Suitable polyacrylate primers are those based on polyacrylic acid, polyacrylic esters and copolymers of monomers having the general formula

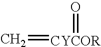

wherein Y stands for H, methyl or ethyl and R denotes a C₁₋₁₂ alkyl group. The polyacrylate resin may be thermoplastic or thermosetting and is preferably dissolved in a solvent. A solution of polymethyl methacrylate (PMMA) in a solvent blend comprising a rapidly evaporating solvent such as propylene glycol methyl ether and a more slowly evaporating solvent such as diacetone alcohol may for example be used as the acrylate resin solution. Particularly suitable acrylate primer solutions are thermoplastic primer compositions containing

(A) polyacrylic resin and

(B) 90 to 99 parts by weight of an organic solvent blend containing

(i) 5 to 25 wt. % of a strong solvent having a boiling point of 150 to 200° C. under normal conditions, in which (A) is freely soluble and

(ii) 75 to 95 wt. % of a weaker solvent having a boiling point of 90 to 150° C. under normal conditions, in which (A) is soluble.

The production, properties and drying of the last-named thermoplastic primer compositions are known to the person skilled in the art and described extensively for example in the publication U.S. Pat. No. 5,041,313. As already mentioned earlier, the primer coat is positioned between the substrate (S) and the scratch-resistant layer (R) and serves to promote adhesion between the two layers.

Other coating compounds for the scratch-resistant layer (R) based on methyl silane and silica sol are described for example in the publications EP 0 570 165 A2, U.S. Pat. No. 4,278,804, U.S. Pat. No. 4,495,360, U.S. Pat. No. 4,624,870, U.S. Pat. No. 4,419,405, U.S. Pat. No. 4,374,674 and U.S. Pat. No. 4,525,426.

(3) Silica Sol-Modified Silyl Acrylate Systems

Polycondensates based on silyl acrylate may also be used as coating compounds for the scratch-resistant layer (R). In addition to silyl acrylate, these coating compounds preferably contain colloidal silicon dioxide (silica sol). Suitable examples of silyl acrylates are in particular acryloxy-functional silanes having the general formula

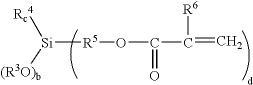

in which R³ and R⁴ are the same or different monovalent hydrocarbon radicals, R⁵ is a divalent hydrocarbon radical having 2 to 8 carbon atoms, R⁶ denotes hydrogen or a monovalent hydrocarbon radical, the index b is a whole number with a value of 1 to 3, the index c is a whole number with a value of 0 to 2 and the index d is a whole number with a value of (4-b-c).

The silyl acrylate coating compositions may optionally further include at least one glycidoxy-functional silanes having the general formula

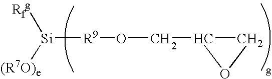

wherein R⁷ and R⁸ are the same or different monovalent hydrocarbon radicals, R⁹ denotes a divalent hydrocarbon radical having 2 to 8 carbon atoms, the index e is a whole number with a value of 1 to 3, the index f is a whole number with a value of 0 to 2 and the index g is a whole number with a value of (4-e-f), and mixtures thereof. The production and properties of these acryloxy-functional silanes and glycidoxy-functional silanes are known in principle to the person skilled in the art and described for example in DE 31 26 662 A1, reference to which is expressly made here.

Particularly suitable acryloxy-functional silanes are for example 3-meth-acryloxypropyl trimethoxysilane, 3-acryloxypropyl trimethoxysilane, 2-methacryloxyethyl trimethoxysilane, 2-acryloxyethyl trimethoxysilane, 3-methacryloxypropyl triethoxysilane, 3-acryloxypropyl triethoxysilane, 2-methacryloxyethyl triethoxysilane and 2-acryloxyethyl triethoxysilane. Particularly suitable glycidoxy-functional silanes are for example 3-glycidoxypropyl trimethoxysi lane, 2-glycidoxyethyl trimethoxysilane, 3-glycidoxypropyl triethoxysilane and 2-glycidoxyethyl triethoxysilane. These compounds are likewise described in DE 31 26 662 A1. As an additional constituent these coating compounds may contain other acrylate compounds, in particular hydroxyacrylates. Other acrylate compounds that may be used are for example 2-hydroxyethyl acrylate, 2-hydroxyethyl methacrylate, 3-hydroxypropyl acrylate, 3-hydroxypropyl methacrylate, 2-hydroxy-3-methacryloxypropyl acrylate, 2-hydroxy-3-acryloxypropyl acrylate, 2-hydroxy-3-methacryloxypropyl methacrylate, diethylene glycol diacrylate, triethylene glycol diacrylate, tetraethylene glycol diacrylate, trimethylol propane triacrylate, tetrahydrofurfuryl methacrylate and 1,6-hexanediol diacrylate. Particularly preferred coating compounds of this type are those containing 100 parts by weight of colloidal silicon dioxide, 5 to 500 parts by weight of silyl acrylate and 10 to 500 parts by weight of other acrylate. After being applied to a substrate (S), such coating compounds combined with a catalytic amount of a photoinitiator may be cured by UV radiation to form a scratch-resistant layer (R) as described in DE 31 26 662 A1. The coating compounds may also contain conventional additives. Particularly suitable are also the radiation-curable scratch-resistant coatings described in U.S. Pat. No. 5,990,188, which in addition to the aforementioned constituents also contain a UV absorber such as triazine or dibenzyl resorcinol derivatives. Other coating compounds based on silyl acrylates and silica sol are described in the publications U.S. Pat. No. 5,468,789, U.S. Pat. No. 5,466,491, U.S. Pat. No. 5,318,850, U.S. Pat. No. 5,242,719 and U.S. Pat. No. 4,455,205.

(4) Silyl Acrylate Systems Modified With Other Nanoparticles

Polycondensates based on silyl acrylates containing nanoscale AlO(OH) particles, in particular nanoscale boehmite particles, as an additional constituent may also be used as coating compounds. Such coating compounds are described for example in the publications WO 98/51747 A1, WO 00/14149 A1, DE 197 46 885, U.S. Pat. No. 5,716,697 and WO 98/04604 A1. By the addition of photoinitiators, after being applied to a substrate (S) these coating compounds may be cured by UV radiation to form a scratch-resistant layer (R).

(5) Cyclic Organosiloxane Systems

Polycondensates based on multifunctional cyclic organosiloxanes may also be used as coating compounds for the scratch-resistant layer (R). Suitable examples of such multifunctional, cyclic organosiloxanes are in particular those having the following formula

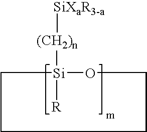

where m=3 to 6, preferably 3 to 4, n=2 to 10, preferably 2 to 5, particularly preferably 2, R=C, to C₈ alkyl and/or C₆ to C₁₄ aryl, preferably C₁ to C₂ alkyl, wherein n and R may be the same or different within the molecule, preferably the same, and wherein the other radicals have the following meaning:

(A) X=halogen, i.e. Cl, Br, I and F, preferably Cl where a=1 to 3 or X=OR′, OH where a=1 to 2, where R′=C, to C₈ alkyl, preferably C₁ to C₂ alkyl, or

(B) X=(OSiR₂)ₚ[(CH₂)ₙSiYₐR₃₋ₐ] where a=1 to 3, wherein within the molecule a may be the same or different, preferably the same,

p=0 to 10, preferably p=0 and

Y=halogen, OR′, OH, preferably Cl, OR′, OH where R′=C₁ to C₈ alkyl, preferably C₁ to C₂ alkyl, or

(C) X=(OSiR₂)ₚ[(CH₂)ₙSiR₃₋ₐ[(CH₂)ₙSiYₐR₃₋ₐ]a] where a=1 to 3, wherein within the molecule a may be the same or different, preferably the same,

p=0 to 10, preferably p=0 and

Y=halogen, OR′, OH, preferably Cl, OR′, OH where R′=C₁ to C₈ alkyl, preferably C₁ to C₂ alkyl.

Particularly suitable are compounds where n=2, m=4, R=methyl and X=OH, OR′ where R′=methyl, ethyl and a=1. The production and properties of such multifunctional cyclic organosiloxanes and their use in scratch-resistant coating compounds are known in principle to the person skilled in the art and are described for example in the publication DE 196 03 241 C1. Other coating compounds based on cyclic organosiloxanes are described for example in the publications WO 98/52992, DE 197 11 650,

WO 98/25274 and WO 98/38251.

(6) Nanoparticle-Modified Epoxysilane Systems

Polycondensates based on hydrolysable silanes with epoxy groups are also suitable as coating compounds for the scratch-resistant layer (R). Preferred scratch-resistant layers (R) are those that may be obtained by curing a coating compound containing a polycondensate produced by the sol-gel process and based on at least one silane, which displays an epoxy group on a non-hydrolysable substituent and optionally a curing catalyst selected from Lewis bases and alcoholates of titanium, zirconium or aluminium. The production and properties of such scratch-resistant layers (R) are described for example in DE 43 38 361 A1.

Preferred coating compounds for scratch-resistant layers based on epoxysilanes and nanoparticles are those containing

a silicon compound (A) displaying at least one non-hydrolysable radical bonded directly to Si, said radical containing an epoxy group,

particulate materials (B),

a hydrolysable compound (C) of Si, Ti, Zr, B, Sn or V and preferably additionally

a hydrolysable compound (D) of Ti, Zr or Al.

Such coating compounds produce highly scratch-resistant coatings that adhere particularly well to the material.

The compounds (A) to (D) are described in more detail below. Compounds (A) to (D) may be included not only in the composition for the scratch-resistant layer (R) but also as additional component(s) in the composition for the topcoat (T).

Silicon Compound (A)

The silicon compound (A) is a silicon compound that has 2 or 3, preferably 3, hydrolysable radicals and one or 2, preferably one, non-hydrolysable radical. The single non-hydrolysable radical or at least one of the two non-hydrolysable radicals has an epoxy group.

Examples of the hydrolysable radicals are halogen (F, Cl, Br and 1, in particular Cl and Br), alkoxy (in particular C₁₋₄ alkoxy such as e.g. methoxy, ethoxy, n-propoxy, i-propoxy and n-butoxy, i-butoxy, sec-butoxy and tert-butoxy), aryloxy (in particular C₆₋₁₀ aryloxy e.g. phenoxy), acyloxy (in particular C₁₋₄ acyloxy such as e.g. acetoxy and propionyloxy) and alkyl carbonyl (e.g. acetyl). Particularly preferred hydrolysable radicals are alkoxy groups, in particular methoxy and ethoxy.

Examples of non-hydrolysable radicals without an epoxy group are hydrogen, alkyl, in particular C₁₋₄ alkyl (such as e.g. methyl, ethyl, propyl and butyl), alkenyl (in particular C₂₋₄ alkenyl such as e.g. vinyl, 1-propenyl, 2-propenyl and butenyl), alkynyl (in particular C₂₋₄ alkynyl such as e.g. acetylenyl and propargyl) and aryl, in particular C₆₋₁₀ aryl such as e.g. phenyl and naphthyl), whereby the aforementioned groups may optionally display one or more substituents such as e.g. halogen and alkoxy. Methacrylic and methacryloxypropyl radicals may also be mentioned in this connection.

Examples of non-hydrolysable radicals with an epoxy group are in particular those having a glycidyl or glycidyloxy group.

Specific examples of silicon compounds (A) for use according to the invention may be found for example on pages 8 and 9 of EP-A-195 493.

Particularly preferred silicon compounds (A) according to the invention are those having the general formula

R₃Si′

in which the radicals R are the same or different (preferably identical) and stand for a hydrolysable group (preferably C₁₋₄ alkoxy and in particular methoxy and ethoxy) and R′ represents a glycidyl or glycidyloxy (C₁₋₂₀) alkylene radical, in particular β-glycidyloxyethyl, γ-glycidyloxypropyl, δ-glycidyloxybutyl, ε-glycidyloxypentyl, ω-glycidyloxyhexyl, ω-glycidyloxyoctyl, ω-glycidyloxynonyl, ω-glycidyloxydecyl, ω-glycidyloxydodecyl and 2-(3,4-epoxycyclohexyl) ethyl.

As it is readily available, γ-glycidyloxypropyl trimethoxysilane (abbreviated below to GPTS) is particularly preferably used according to the invention.

Particulate Materials (B)

The particulate materials (B) are an oxide, oxide hydrate, nitride or carbide of Si, Al and B and of transition metals, preferably Ti, Zr and Ce, with a particle size in the range from 1 to 100, preferably 2 to 50 nm and particularly preferably 5 to 20 nm, and mixtures thereof. These materials may be used in the form of a powder, but are preferably used in the form of a sol (particularly an acid-stabilised sol). Preferred particulate materials are boehmite, SiO₂, CeO₂, ZnO, In₂O₃ and TiO₂. Nanoscale boehmite particles are particularly preferred. The particulate materials are commercially available in the form of powders, and the production of (acid-stabilised) sols from them is likewise known in the prior art. Reference may also be made in this connection to the production examples provided below. The principle of stabilising nanoscale titanium nitride with guanidine propionic acid is described for example in German patent application DE-A-43 34 639.

Boehmite sol with a pH in the range from 2.5 to 3.5, preferably 2.8 to 3.2, which may be obtained for example by suspending boehmite powder in dilute HCl, is particularly preferably used.

The variation in the nanoscale particles is generally associated with a variation in the refractive index of the corresponding materials. Thus for example replacing boehmite particles by CeO₂, ZrO₂ or TiO₂ particles leads to materials with higher refractive indexes, the refractive index being calculated cumulatively by the Lorentz-Lorenz equation from the volume of the high-refracting component and the matrix

As mentioned, cerium dioxide may be used as the particulate material.

This preferably displays a particle size in the range from 1 to 100, preferably 2 to 50 nm and particularly preferably 5 to 20 nm. This material may be used in the form of a powder, but is preferably used in the form of a sol (particularly an acid-stabilised sol). Particulate cerium oxide is commercially available in the form of sols and powders and the production of (acid-stabilised) sols from them is likewise known in the prior art.

Compound (B) is preferably used in the composition for the scratch-resistant layer (R) in a quantity of 3 to 60 wt. %, relative to the solids content of the coating compound for the scratch-resistant layer (R).

Hydrolysable Compounds (C)

In addition to the silicon compounds (A), other hydrolysable compounds of elements from the group comprising Si, Ti, Zr, Al, B, Sn and V may also be used in the production of the scratch-resistant layer coating composition and preferably hydrolysed together with the silicon compound(s) (A).

The compound (C) is a compound of Si, Ti, Zr, B, Sn and V having the general formula

RₓM⁺⁴R′₄₋ₓ or

RₓM⁺³R′₃₋ₓ

wherein M represents a) Si⁺⁴, Ti⁺⁴, Zr⁺⁴, Sn⁺⁴, or b) Al⁺³, B⁺³ or (VO)⁺³, R represents a hydrolysable radical, R′ represents a non-hydrolysable radical and x may be 1 to 4 in the case of tetravalent metal atoms M (case a)) and 1 to 3 in the case of trivalent metal atoms M (case b)). If several radicals R and/or R′ are present in a compound (C), then they may each be the same or different. x is preferably greater than 1. In other words the compound (C) displays at least one, preferably more than one hydrolysable radical.

Examples of the hydrolysable radicals are halogen (F, Cl, Br and 1, in particular C₁ and Br), alkoxy (in particular C₁₋₄ alkoxy such as e.g. methoxy, ethoxy, n-propoxy, i-propoxy and n-butoxy, i-butoxy, sec-butoxy or tert-butoxy), aryloxy (in particular C₆₋₁₀ aryloxy, e.g. phenoxy), acyloxy (in particular C₁₋₄ acyloxy such as e.g. acetoxy and propionyloxy) and alkyl carbonyl (e.g. acetyl). Particularly preferred hydrolysable radicals are alkoxy groups, in particular methoxy and ethoxy.

Examples of non-hydrolysable radicals are hydrogen, alkyl, in particular C₁₋₄ alkyl (such as e.g. methyl, ethyl, propyl and n-butyl, i-butyl, sec-butyl and tert-butyl), alkenyl (in particular C₂₋₄ alkenyl such as e.g. vinyl, 1-propenyl, 2-propenyl and butenyl), alkynyl (in particular C₂₋₄ alkynyl such as e.g. acetylenyl and

propargyl) and aryl, in particular C₆₋₁₀ aryl, such as e.g. phenyl and naphthyl), whereby the aforementioned groups may optionally display one or more substituents, such as e.g. halogen and alkoxy. Methacrylic and methacryloxypropyl radicals may also be mentioned in this connection.

In addition to those cited as examples for the compounds having formula I contained in the topcoat composition, the following preferred examples for compound (C) may be cited:

CH₃—SiCl₃, CH₃—Si(OC₂H₅)₃, C₂H₅—SiCl₃, C₂H₅—Si(OC₂H₅)₃,

C₃H₇—Si(OCH₃)₃, C₆H₅—Si(OCH₃)₃, C₆H₅—Si(OC₂H₅)₃,

(CH₃O)₃—Si—C₃H₆—Cl,

(CH₃)₂SiCl₂, (CH₃)₂Si(OCH₃)₂, (CH₃)₂Si(OC₂H₅)₂,

(CH₃)₂Si(OH)₂, (C₆H₅)₂SiCl₂, (C₆H₅)₂Si(OCH₃)₂,

(C₆H₅)₂Si(OC₂H₅)₂, (i-C₃H₇)₃SiOH,

CH₂═CH—Si(OOCCH₃)₃,

CH₂═CH—SiCl₃, CH₂═CH—Si(OCH₃)₃, CH₂═CH—Si(OC₂H₅)₃,

CH₂═CH—Si(OC₂H₄OCH₃)₃, CH₂═CH—CH₂—Si(OCH₃)₃,

CH₂═CH—CH₂—Si(OC₂H₅)₃,

CH₂═CH—CH₂—Si(OOCCH₃)₃,

CH₂═C(CH₃)—COO—C₃H₇—Si(OCH₃)₃,

CH₂═C(CH₃)—COO—C₃H₇—Si(OC₂H₅)₃.

Compounds of the type SiR₄ are particularly preferably used, wherein the radicals R may be the same or different and stand for a hydrolysable group, preferably for an alkoxy group having 1 to 4 carbon atoms, in particular for methoxy, ethoxy, n-propoxy, i-propoxy, n-butoxy, i-butoxy, sec-butoxy or tert.-butoxy.

As may be seen, these compounds (C) (particularly the silicon compounds) may also have non-hydrolysable radicals displaying a C—C double or triple bond. If such compounds are used together with (or even in place of) the silicon compounds (A), monomers (preferably containing epoxy or hydroxyl groups) such as e.g. meth(acrylates) may also additionally be incorporated into the composition (naturally these monomers may also have two or more functional groups of the same type, such as e.g. poly(meth)acrylates of organic polyols; the use of organic polyepoxides is also possible). During thermal or photochemically induced curing of the corresponding composition, in addition to synthesis of the organically modified inorganic matrix, polymerisation of the organic species then occurs, as a result of which the crosslinking density and hence also the hardness of the corresponding coatings and moulded articles increases.

Compound (C) is preferably used in the composition for the scratch-resistant layer (R) in a quantity of 0.2 to 1.2 mol, relative to 1 mol of silicon compound (A).

Hydrolysable Compound (D)

The hydrolysable compound (D) is a compound of Ti, Zr or Al having the following general formula

M(R′″)ₘ

wherein M stands for Ti, Zr or Al and the radicals R′″ may be the same or different and may stand for a hydrolysable group and n is 4 (M=Ti, Zr) or 3 (M=Al).

Examples of the hydrolysable groups are halogen (F, Cl, Br and 1, in particular Cl and Br), alkoxy (in particular C₁₋₆ alkoxy such as e.g. methoxy, ethoxy, n-propoxy, i-propoxy and n-butoxy, i-butoxy, sec-butoxy or tert-butoxy, n-pentyloxy, n-hexyloxy), aryloxy (in particular C₆₋₁₀ aryloxy e.g. phenoxy), acyloxy (in particular C₁₋₄ acyloxy such as e.g. acetoxy and propionyloxy) and alkyl carbonyl (e.g. acetyl), or a C₁₋₆ alkoxy C₂₋₃ alkyl group, i.e. a group derived from C₁₋₆ alkyl ethylene glycol or propylene glycol, alkoxy having the same meaning as mentioned above.

M is particularly preferably aluminium and R′″ ethoxy, sec-butoxy, n-propoxy or n-butoxyethoxy.

Compound (D) is preferably used in the composition for the scratch-resistant layer (R) in a quantity of 0.23 to 0.68 mol, relative to 1 mol of silicon compound (A).

In order to obtain a hydrophilic character for the scratch-resistant coating compound, a Lewis base (E) may additionally be used as catalyst.

In addition, a hydrolysable silicon compound (F) having at least one non-hydrolysable radical displaying 5 to 30 fluorine atoms that are bonded directly to carbon atoms may also be used, said carbon atoms being separated from Si by at least 2 atoms. The use of a silane fluorinated in this way means that the corresponding coating additionally displays hydrophobic and dirt-repellent properties.

The compositions for the scratch-resistant layer (R) may be produced by the process that is described in greater detail below, wherein a sol of the material (B) having a pH in the range from 2.0 to 6.5, preferably 2.5 to 4.0, is reacted with a mixture of the other components.

They are even more preferably produced by a process that is likewise defined below, wherein the sol as defined above is added to the mixture of (A) and (C) in two sub-portions, specific temperatures preferably being maintained and (D) being added between the two portions of (B), again preferably at a specific temperature.

The hydrolysable silicon compound (A) may optionally be prehydrolysed in aqueous solution together with the compound (C) using an acid catalyst (preferably at room temperature), whereby preferably around ½ mol of water is used per mol of hydrolysable group. Hydrochloric acid is preferably used as the catalyst for the prehydrolysis.

The particulate materials (B) are preferably suspended in water and the pH adjusted to 2.0 to 6.5, preferably 2.5 to 4.0. Hydrochloric acid is preferably used for acidification. If boehmite is used as the particulate material (B), a clear sol is formed under these conditions.

Compound (C) is mixed with compound (A). The first sub-portion of the particulate material (B), suspended as described above, is then added. The amount is preferably chosen such that the water it contains is sufficient for the semi-stoichiometric hydrolysis of compounds (A) and (C). It amounts to 10 to 70 wt. % of the total amount, preferably 20 to 50 wt. %.

The reaction is slightly exothermic. When the first exothermic reaction has died down, the temperature is adjusted by heating to around 28 to 35° C., preferably around 30 to 32° C., until the reaction kicks off and an internal temperature is obtained that is higher than 25° C., preferably higher than 30° C. and even more preferably higher than 35° C. Following addition of the first portion of material (B), the temperature is maintained for a further 0.5 to 3 hours, preferably 1.5 to 2.5 hours, and then reduced to approx. 0° C. The remaining material (B) is preferably added slowly at a temperature of 0° C. The compound (D) and optionally the Lewis base (E) are then added slowly at a temperature of around 0° C., again preferably after addition of the first sub-portion of material (B). The temperature is then held at around 0° C. for 0.5 to 3 hours, preferably for 1.5 to 2.5 hours, before the second portion of material (B) is added. The remaining material (B) is then added slowly at a temperature of around 0° C. The solution, which is added dropwise, is preferably precooled in the reactor to approx. 10° C. immediately before being added.

After the slow addition of the second sub-portion of compound (B) at approx. 0° C., cooling is preferably removed so that the reaction mixture may heat up slowly to a temperature of over 15° C. (up to room temperature) without additional heating.

In order to adjust the rheological properties of the scratch-resistant layer compositions, inert solvents or solvent blends may optionally be added at any stage of the production process. These solvents are preferably the solvents described for the topcoat composition.

The scratch-resistant layer compositions may contain the conventional additives described for the topcoat composition.

Application and curing of the scratch-resistant layer composition is preferably performed thermally at 50 to 200° C., preferably 70 to 180° C. and in particular 110 to 130° C. after surface drying. Under these conditions the cure time should be less than 120, preferably less than 90, in particular less than 60 minutes.

The film thickness of the cured scratch-resistant layer (R) should be 0.5 to 30 μm, preferably 1 to 20 μm and in particular 2 to 10 μm.

Production of the Topcoat (T)

The highly scratch-resistant topcoat (T) is produced by application of a solvent-containing silane-based coating compound onto the surface-treated scratch-resistant layer (R) and curing thereof.

The coating compounds for the topcoat (T) may for example be the coating sols produced from tetraethoxysilane (TEOS) and glycidyloxypropyl trimethoxysilane (GPTS) known from DE 199 52 040 A1.

The coating sol is produced by prehydrolysing TEOS with ethanol as solvent in HCl-acidic aqueous solution followed by condensation. GPTS is then stirred into the prehydrolysed TEOS and the sol stirred with heating for some time.

Coating compounds for the topcoat (T) for use in the production process according to the invention are also those that are obtainable by hydrolysing

(a) one or more compounds having the general formula I

M(R′)ₘ (I)

wherein M is an element or a compound selected from the group consisting of Si, Ti, Zr, Sn, Ce, Al, B, VO, In and Zn, R′ represents a hydrolysable radical and m is a whole number from 2 to 4, alone or together with

(b) one or more compounds having the general formula 11

R_{b}SiR′ₐ, (II)

wherein the radicals R′ and R are the same or different, R′ is as defined above, R represents an alkyl group (preferably C₁-C₈), an alkenyl group (preferably C₂-C₈), an aryl group (preferably C₆-C₁₀) or a hydrocarbon group (preferably C₁-C₂₀) with one or more halogen groups, an epoxy group, a glycidyloxy group, an amino group, a mercapto group, a methacryloxy group or a cyano group and a and b mutually independently assume the values 1 to 3, the sum of a and b equalling four,

in the presence of at least 0.6 mol of water, relative to 1 mol of hydrolysable radicals R′.

The compounds having formulae I and II may be used in any quantities. The compound having formula II is preferably used in a quantity of less than 0.7 mol, in particular less than 0.5 mol, relative to 1 mol of the compound having formula I.

The hydrolysis is preferably performed in the presence of acids, in particular aqueous hydrochloric acid. A reaction mixture pH of 2.0 to 5.0 is particularly suitable.

The hydrolysis reaction is slightly exothermic and is preferably supported by heating to 30 to 40° C. Following hydrolysis the reaction product is preferably cooled to room temperature and stirred for some time, particularly 1 to 3 hours, at room temperature. The coating composition obtained is preferably stored at temperatures <10° C., in particular at a temperature of around 4° C.

All stated temperatures include a deviation of ±2° C. Room temperature means a temperature of 20 to 23° C.

The topcoat coating sol is produced from 100 parts of a compound having formula I and/or a hydrolysis product thereof and a compound having formula II and/or a hydrolysis product thereof, the amount of compound II, relative to the 100 parts of compound I, being less than 100 parts, preferably less than 70 parts, in particular less than 50 parts, or being omitted entirely. The ready-to-use topcoat coating composition preferably has a solids content of 0.2 to 10%, in particular 0.5 to 5%.

The compound having formula I is preferably a compound

M(R′)ₘ

wherein M stands for a) Si⁺⁴, Ti⁺⁴, Zr⁺⁴, Sn⁺⁴, Ce⁺⁴ or b) Al⁺³, B⁺³, VO⁺³ In⁺³ or c) Zn⁺², R′ represents a hydrolysable radical and m is 4 in the case of tetravalent elements M [case a)], 3 in the case of trivalent elements or compounds M [case b)] and 2 in the case of divalent elements [case c)]. Preferred elements for M are Si⁺⁴, Ti⁺⁴, Ce⁺⁴ and Al⁺³, with Si⁺⁴ being particularly preferred.

Examples of the hydrolysable radicals are halogen (F, Cl, Br and I, in particular Cl and Br), alkoxy (in particular C₁₋₄ alkoxy such as e.g. methoxy, ethoxy, n-propoxy, i-propoxy and n-butoxy, i-butoxy, sec-butoxy or tert.-butoxy), aryloxy (in particular C₆₋₁₀ aryloxy, e.g. phenoxy), acyloxy (in particular C₁₋₄ acyloxy such as e.g. acetoxy and propionyloxy) and alkyl carbonyl (e.g. acetyl). Alkoxy groups, in particular methoxy and ethoxy, are particularly preferred hydrolysable radicals.

Specific examples of compounds having formula I that may be used are listed below, although this is not intended to represent any restriction of the compounds having formula I that may be used.

Si(OCH₃)₄, Si(OC₂H₅)₄, Si(O-n- or i-C₃H₇)₄,

Si(OC₄H₉)₄, SiCl4, HSiCl₃, Si(OOCCH₃)₄,

Al(OCH₃)₃, Al(OC₂H₅)₃, Al(O-n-C₃H₇)₃,

Al(O-i-C₃H₇)₃, Al(OC₄H₉)₃, Al(O-i-C₄H₉)₃,

Al(O-sec-C₄H₉)₃, AlCl3, AlCl(OH)₂, Al(OC₂H₄OC₄H₉)₃,

TiCl₄, Ti(OC₂H₅)₄, Ti(OC₃H₇)₄,

Ti(O-1-C₃H₇)₄, Ti(OC₄H₉)₄, Ti(2-ethyl hexoxy)₄;

ZrCl₄, Zr(OC₂H₅)₄, Zr(OC₃H₇)₄, Zr(O-1-C₃H₇)₄, Zr(OC₄H₉)₄,

ZrOCl₂, Zr(2-ethyl hexoxy)₄

and Zr compounds displaying complexing radicals such as e.g. β-diketone and methacrylic radicals,

BCl₃, B(OCH₃)₃, B(OC₂H₅)₃,

SnCl₄, Sn(OCH₃)₄,

Sn(OC₂H₅)₄,

VOCl₃, VO(OCH₃)₃,

Ce(OC₂H₅)₄, Ce(OC₃H₄)₄, Ce(OC₄H₉), Ce(O-i-C₃H₇)₄, Ce(2-ethyl hexoxy)₄,

Ce(SO₄)₂, Ce(ClO₄)₄, CeF₄, CeCl₄, CeAc₄,

In(CH₃COO)₃, In[CH₃COCH═C(O—)CH₃]₃,

InBr₃, [(CH₃)₃CO]₃In, InCl₃, InF₃,

[(CH₃I₂)CHO]₃In, InI₃, In(NO₃)₃, In(CIO₄)₃, In₂ (SO₄)₃, In₂S₃,

(CH₃COO)₂Zn, [CH₃COCH═C(O—)CH₃]₂Zn,

ZnBr₂, ZnCO₃.2 Zn(OH)₂ x H₂O, ZnCl₂,

zinc citrate, ZnF₂, ZnI, Zn(NO₃)₂.H₂O, ZnSO₄.H₂O.

SiR₄ compounds are particularly preferably used, wherein the radicals R may be the same or different and stand for a hydrolysable group, preferably for an alkoxy group having 1 to 4 carbon atoms, in particular for methoxy, ethoxy, n-propoxy, i-propoxy, n-butoxy, i-butoxy, sec-butoxy or tert.-butoxy.

Tetraethoxysilane (TEOS) is most particularly preferred.

The compound having formula II is preferably a compound

R_{b}SiR′ₐ, (II)

wherein the radicals R and R′ are the same or different (preferably identical), R′ stands for a hydrolysable group (preferably C₁₋₁₄ alkoxy and in particular methoxy and ethoxy) and R stands for an alkyl group, an alkenyl group, an aryl group or a hydrocarbon group with one or more halogen groups, an epoxy group, a glycidyloxy group, an amino group, a mercapto group, a methacryloxy group or a cyano group.

a may assume the values 1 to 3 and

b likewise the values 1 to 3,

the sum a+b equalling four.

Examples of compounds having formula II are:

Trialkoxysilanes, triacyloxysilanes and triphenoxysilanes such as methyl trimethoxysilane, methyl triethoxysilane, methyl trimethoxyethoxysilane, methyl triacetoxysilane, methyl tributoxysilane, ethyl trimethoxysilane, ethyl triethoxysilane, vinyl trimethoxysilane, vinyl triethoxysilane, vinyl triacetoxysilane, vinyl trimethoxyethoxysilane, phenyl trimethoxysilane, phenyl triethoxysilane, phenyl triacetoxysilane, γ-chloropropyl trimethoxysilane, γ-chloropropyl triethoxysilane,

γ-chloropropyl triacetoxysilane, 3,3,3-trifluoropropyl trimethoxysilane, γ-methacryloxypropyl trimethoxysilane, γ-aminopropyl trimethoxysilane, γ-mercaptopropyl trimethoxysilane, γ-mercaptopropyl triethoxysilane, N-β-(aminoethyl)-γ-aminopropyl trimethoxysilane, β-cyanoethyl triethoxysilane, methyl triphenoxysilane, chloromethyl trimethoxysilane, chloromethyl triethoxysilane, glycidoxymethyl trimethoxysilane, glycidoxymethyl triethoxysilane,

α-glycidoxyethyl trimethoxysilane, α-glycidoxyethyl triethoxysilane, β-glycidoxyethyl trimethoxysilane, β-glycidoxyethyl triethoxysilane, α-glycidoxypropyl trimethoxysilane, α-glycidoxypropyl triethoxysilane, β-glycidoxypropyl trimethoxysilane, β-glycidoxypropyl triethoxysilane, γ-glycidoxypropyl trimethoxysilane, γ-glycidoxypropyl triethoxysilane, γ-glycidoxypropyl tripropoxysilane, γ-glycidoxypropyl tributoxysilane, γ-glycidoxypropyl trimethoxyethoxysilane, γ-glycidoxypropyl triphenoxysilane,

α-glycidoxybutyl trimethoxysilane, α-glycidoxybutyl triethoxysilane,

β-glycidoxybutyl trimethoxysilane, β-glycidoxybutyl triethoxysilane,

γ-glycidoxybutyl trimethoxysilane, γ-glycidoxybutyl triethoxysilane,

δ-glycidoxybutyl trimethoxysilane, δ-glycidoxybutyl triethoxysilane,

(3,4-epoxycyclohexyl) methyl trimethoxysilane,

(3,4-epoxycyclohexyl) methyl triethoxysilane,

β-(3,4-epoxycyclohexyl) ethyl trimethoxysilane,

β-(3,4-epoxycyclohexyl) ethyl triethoxysilane,

β-(3,4-epoxycyclohexyl) ethyl tripropoxysilane,

β-(3,4-epoxycyclohexyl) ethyl tributoxysilane,

β(3,4-epoxycyclohexyl) ethyl dimethoxyethoxysilane,

β-(3,4-epoxycyclohexyl) ethyl triphenoxysilane,

γ-(3,4-epoxycyclohexyl) propyl trimethoxysilane,

γ-(3,4-epoxycyclohexyl) propyl triethoxysilane,

δ-(3,4-epoxycyclohexyl) butyl trimethoxysilane,

δ-(3,4-epoxycyclohexyl) butyl triethoxysilane and hydrolysis products thereof and dialkoxysilanes and diacyloxysilanes such as e.g. dimethyl dimethoxysilane, phenyl methyl dimethoxysilane, dimethyl diethoxysilane, phenyl methyl diethoxysilane,

γ-chloropropyl methyl dimethoxysilane, γ-chloropropyl methyl diethoxysilane, dimethyl diacetoxysilane, γ-methacryloxypropyl methyl dimethoxysilane,

γ-methacryloxypropyl methyl diethoxysilane, γ-mercaptopropyl methyl dimethoxysilane, γ-mercaptopropyl methyl diethoxysilane, γ-aminopropyl methyl dimethoxysilane,

γ-aminopropyl methyl diethoxysilane, methyl vinyl dimethoxysilane, methyl vinyl diethoxysilane, glycidoxymethyl methyl dimethoxysilane, glycidoxymethyl methyl diethoxysilane, α-glycidoxyethyl methyl dimethoxysilane,

α-glycidoxyethyl methyl diethoxysilane, β-glycidoxyethyl methyl dimethoxysilane,

β-glycidoxyethyl methyl diethoxysilane, α-glycidoxypropyl methyl dimethoxysilane,

α-glycidoxypropyl methyl diethoxysilane,

β-glycidoxypropyl methyl dimethoxysilane,

β-glycidoxypropyl methyl diethoxysilane,

γ-glycidoxypropyl methyl dimethoxysilane,

γ-glycidoxypropyl methyl diethoxysilane,

γ-glycidoxypropyl methyl dipropoxysilane,

γ-glycidoxypropyl methyl dibutoxysilane,

γ-glycidoxypropyl methyl dimethoxyethoxysilane,

γ-glycidoxypropyl methyl diphenoxysilane,

γ-glycidoxypropyl ethyl dimethoxysilane, γ-glycidoxypropyl ethyl diethoxysilane,

γ-glycidoxypropyl ethyl dipropoxysilane, γ-glycidoxypropyl vinyl dimethoxysilane,

γ-glycidoxypropyl vinyl diethoxysilane, γ-glycidoxypropyl phenyl dimethoxysilane,

γ-glycidoxypropyl phenyl diethoxysilane, products and hydrolysis products thereof.

These products may be used individually or as a mixture of two or more.

Preferred compounds having formula II are methyl trialkoxysilane, dimethyl dialkoxysilane, glycidyloxypropyl trialkoxysilane and/or methacryloxypropyl trimethoxysilane. Particularly preferred compounds having formula II are glycidyloxypropyl trimethoxysilane (GPTS), methyl triethoxysilane (MTS) and/or methacryloxypropyl trimethoxysilane (MPTS).

In order to adjust the rheological properties of the compositions, water and inert solvents or solvent blends may optionally be added at any stage of the production process, particularly during hydrolysis. These solvents are preferably alcohols that are liquid at room temperature, which incidentally are also produced during hydrolysis of the alkoxides that are preferably used. Particularly preferred alcohols are C₁₋₈ alcohols, in particular methanol, ethanol, n-propanol, i-propanol, n-butanol, i-butanol, tert-butanol, n-pentanol, i-pentanol, n-hexanol, n-octanol. Likewise preferred are C₁₋₆ glycol ethers, in particular n-butoxyethanol. Isopropanol, ethanol, butanol and/or water are particularly suitable as solvents.

The compositions may also contain conventional additives such as e.g. dyes, flow control agents, UV stabilisers, IR stabilisers, photoinitiators, photosensitisers (if the composition is intended to be cured photochemically) and/or thermal polymerisation catalysts. Flow control agents are in particular those based on polyether-modified polydimethyl siloxanes. It has proven to be particularly advantageous if the compositions contain flow control agents in a quantity of around 0.005 to 2 wt. %.

Application onto the substrate (S) coated with the scratch-resistant layer (R) is performed by standard coating methods such as e.g. dip coating, flow coating, spreading, brushing, knife application, roll coating, spraying, falling film application, spin coating and centrifugal casting.

The coated substrate is optionally cured following prior surface drying at room temperature. Curing is preferably performed thermally at temperatures in the range from 50 to 200° C., in particular 70 to 180° C. and particularly preferably 90 to 150° C. Under these conditions the cure time should be 30 to 200 minutes, preferably 45 to 120 minutes. The film thickness of the cured topcoat should be 0.05 to 5 μm, preferably 0.1 to 3 μm.

If unsaturated compounds and photoinitiators are present, curing may also be performed by irradiation, optionally followed by thermal post-curing.

It has also been found to be particularly advantageous if the topcoat coating compound is applied at a relative humidity of 50 to 75%, in particular 55 to 70%.

The invention is explained in more detail below by means of embodiment examples.

### EXAMPLE 1

354.5 g (3.0 mol) n-butoxyethanol were added dropwise to 246.3 g (1.0 mol) aluminium tri-sec-butanolate with stirring, during which process the temperature rose to approximately 45° C. After cooling the aluminate solution must be stored in a closed container.

1239 g 0.1N HCl were measured out. 123.9 g (1.92 mol) boehmite (Disperal Sol P3® from Condea) were added with stirring. Stirring was then continued for 1 hour at room temperature. The solution was filtered through a depth filter to separate off solid impurities.

787.8 g (3.33 mol) GPTS (γ-glycidyloxypropyl trimethoxysilane) and 608.3 g TEOS (tetraethoxysilane) (2.92 mol) were mixed and stirred for 10 minutes. 214.6 g of the boehmite sol were added to this mixture within approx. 2 minutes. A few minutes after this addition, the sol heated up to approx. 28 to 30° C. and was still clear even after approx. 20 minutes. The mixture was then stirred for approx. 2 hours at 35° C. and then cooled to approx. 0° C.

600.8 g of the Al(OEtOBu)₃ solution in sec.-butanol, containing 1.0 mol Al(OEtOBu)₃, produced as described above, were then added at 0° C.±2° C. Following this addition stirring was continued for a further 2 hours at approx. 0° C. and the remaining boehmite sol then added, again at 0° C.±2° C. The reaction mixture obtained then heated up to room temperature without the application of heat in approx. 3 hours. Byk® 306 from Byk was added as flow control agent. The mixture was filtered and the coating obtained was stored at +4° C.

### EXAMPLE 2

GPTS and TEOS are measured out and mixed. The quantity of boehmite dispersion (produced in the same way as in Example 1) needed for semi-stoichiometric prehydrolysis of the silanes is then slowly added with stirring. The reaction mixture is then stirred for 2 hours at room temperature. The solution is then cooled to 0° C. with the aid of a cryostat. Aluminium tributoxyethanolate is then added dropwise using a dropping funnel. Stirring is continued for a further 1 hour at 0° C. after addition of the aluminate. The rest of the boehmite dispersion is then added with cryostat cooling. After stirring for 15 minutes at room temperature, the cerium dioxide dispersion and BYK® 306 as flow control agent are added.

| | | |
|---|---|---|
| TEOS | 62.50 | g (0.3 mol) |
| GPTS | 263.34 | g (1 mol) |
| Boehmite | 5.53 | g |
| 0.1 n hydrochloric acid | 59.18 | g |
| Cerium dioxide dispersion | 257.14 | g |
| (20 wt. % in 2.5 wt. % acetic acid) | | |
| Boehmite dispersion for | 41.38 | g |
| semi-stoichiometric prehydrolysis | | |
| Aluminium tributoxyethanolate | 113.57 | g (0.3 mol) |

### EXAMPLE 3

### PRIMER

The primer solution is produced by dissolving 6 g Araldit PZ 3962 and 1.3 g Araldit PZ 3980 in 139.88 g diacetone alcohol at room temperature as described in patent application PCT/EP01/03809.

### EXAMPLE 4

203 g methyl trimethoxysilane were mixed with 1.25 g glacial acetic acid. 125.5 g Ludox® AS (ammonium-stabilised colloidal silica sol from DuPont, 40% SiO₂ with a silicate particle diameter of around 22 nm and a pH of 9.2) were diluted with 41.5 g deionised water to adjust the content of SiO₂ to 30 wt. %. This material was added to the acidified methyl trimethoxysilane with stirring. The solution was stirred for a further 16 to 18 hours at room temperature and then added to a solvent blend consisting of isopropanol/n-butanol in the weight ratio 1:1. Finally 32 g of the UV absorber 4-[γ-(tri-(methoxy/ethoxy)silyl)propoxy]-2-hydroxybenzophenone were added. The mixture was stirred for two weeks at room temperature.

The composition had a solids content of 20 wt. % and contained 11 wt. % of the UV absorber, relative to the solid constituents. The coating composition had a viscosity of around 5 cSt at room temperature.

0.2 wt. % tetrabutyl ammonium acetate were incorporated homogeneously before application to accelerate the polycondensation reaction.

### EXAMPLE 5

### PRIMER

3.0 parts polymethyl methacrylate (Elvacite® 2041 from DuPont) were mixed with 15 parts diacetone alcohol and 85 parts propylene glycol monomethyl ether and stirred for two hours at 70° C. until completely dissolved.

### EXAMPLE 6

0.4 wt. % of a silicon flow control agent and 0.3 wt. % of an acrylate polyol, namely Joncryl 587 (Mₙ 4300) from S.C. Johnson Wax Company in Racine, Wis., were stirred into the coating sol produced according to Example 4. As in Example 4, 0.2 wt. % tetra-n-butyl ammonium acetate were incorporated homogeneously before application to accelerate the polycondensation reaction.

### EXAMPLE 7

A mixture of 130.0 g 2-propanol, 159.4 g distilled water and 2.8 g 37% hydrochloric acid was quickly added dropwise to a mixture of 200.0 g TEOS, 22.0 g MTS in 130.0 g 2-propanol. An exothermic reaction occurs, which is supported by heating to 30 to 40° C. The reaction product is then cooled to room temperature and stirred for 1.5 hours. The coating sol obtained is stored in a cool place at +4° C. Before application this concentrate is diluted with isopropanol to a solids content of 1 wt. % and 1.0 wt. % flow control agent BYK® 347 (relative to the solids content) is added.

### EXAMPLE 8

A mixture of 130.0 g 2-propanol, 145.4 g distilled water and 2.8 g 37% hydrochloric acid was quickly added dropwise to a mixture of 200.0 g TEOS in 130.0 g 2-propanol. An exothermic reaction occurs, which is supported by heating to 30 to 40° C. The reaction product is then cooled to room temperature and stirred for 1.5 hours. The coating sol obtained is stored in a cool place at +4° C. Before application this concentrate is diluted with isopropanol to a solids content of 1 wt. % and 1.0 wt. % flow control agent BYK® 306 (relative to the solids content) is added.

### EXAMPLE 9

A mixture of 130.0 g 2-propanol, 156.8 g distilled water and 2.8 g 37% hydrochloric acid was quickly added dropwise to a mixture of 200.0 g TEOS, 22.0 g GPTS in 130.0 g 2-propanol. An exothermic reaction occurs, which is supported by heating to 30 to 40° C. The reaction product is then cooled to room temperature and stirred for 1.5 hours. The coating sol obtained is stored in a cool place at +4° C. Before application this concentrate is diluted with isopropanol to a solids content of 1 wt. % and 1.0 wt. % flow control agent BYK 347 (relative to the solids content) is added.

Production of the Scratch-Resistant Coating Systems

Specimens were produced as follows with the coating compounds obtained:

Sheets of polycarbonate based on bisphenol A (Tg=147° C., M_{w} 27500) measuring 105×150×4 mm were cleaned with isopropanol and optionally primed by flow coating with a primer solution.

The primer solution is allowed to become touch dry and in the case of the primer (Example 3) then additionally heat treated for half an hour at 130° C.

The primed polycarbonate sheets were then flow coated with the scratch-resistant coating compound (Example 1, 2, 4). Priming is omitted in the case of the scratch-resistant coating compound from Example 6. The time required for the sheets to become dust dry was 30 minutes at 23° C. and 63% relative humidity. The dust-dry sheets were heated in an oven at 130° C. for 30 to 60 minutes and then cooled to room temperature.

Surface activation of the cured scratch-resistant layer was then performed by flame treatment, corona treatment or plasma treatment to improve adhesion and the flow behaviour of the topcoat coating compounds.

The topcoat coating compounds (Example 7, 8, 9) were then applied, again by flow coating. The wet film was allowed to dry for 30 minutes at 23° C. and 63% relative humidity and the sheets were then heated for 120 minutes at 130° C.

After curing the coated sheets were stored for two days at room temperature and then put through the following defined tests.

The properties of the coatings obtained with these coating compounds were determined as follows:

Cross-hatch adhesion test: EN ISO 2409:1994

Taber abraser test: Abrasion test DIN 52 347; (1000 cycles, CS10F, 500 g).

The results of the assessment are set out in Tables 1 and 2.

The abrasion (Taber values) and adhesion (cross-cut test) properties of the coating systems that were produced are set out in the tables. The results show that the coating systems produced by the process according to the invention display considerably better abrasion and adhesion properties than those without activation.

TABLE 1

| | | Scratch- | | | Surface | | | Taber |
|---|---|---|---|---|---|---|---|---|
| Example | | resistant | | | tension | | Cross- | 1000 |
| no. | Primer P | layer R | Topcoat T | Activation | mN/m | Wetting | cut | cycles |
| 10 | Example 3 | Example 2 | Example 8 | None | 36 | Holes | n.d. | n.d. |
| 11 | Example 3 | Example 2 | Example 8 | 1 × flame treatment, | 55 | Good | 0/0 | 2.2 |
| | | | | throughput 3 m/min | | | | |
| 12 | Example 3 | Example 2 | Example 8 | 1 × flame treatment, | 66 | Good | 0/0 | 2.5 |
| | | | | throughput 3 m/min | | | | |
| 13 | Example 3 | Example 2 | Example 7 | None | 34 | Holes | n.d. | n.d. |
| 14 | Example 3 | Example 2 | Example 7 | Corona 1000 W | 48 | Good | 0/0 | 4.1 |
| 15 | Example 3 | Example 2 | Example 7 | Corona 1500 W | 56 | Good | 0/0 | 4.7 |
| 16 | Example 3 | Example 2 | Example 7 | 2 x corona 1500 W | >56 | Very good | 0/0 | 3.4 |
| 17 | Example 3 | Example 1 | Example 8 | None | 24 | Many holes | n.d. | n.d. |
| | | | | | | and craters | | |
| 18 | Example 3 | Example 1 | Example 8 | Corona 1000 W | 48 | Good | 0/0 | 4.1 |
| 19 | Example 3 | Example 1 | Example 8 | Corona 1500 W | 56 | Good | 0/0 | 2.2 |
| 20 | Example 3 | Example 1 | Example 8 | 2 × corona 1500 W | >56 | Very good | 0/0 | 2.3 |
| 21 | None | Example 6 | Example 8 | None | 26 | None, | n.d. | n.d. |
| | | | | | | repellent effect | | |
| 22 | None | Example 6 | Example 8 | Continuous corona | 48 | Good | 0/0 | 7.6 |
| 23 | Example 5 | Example 4 | Example 8 | None | 24 | Many holes | n.d. | n.d. |
| | | | | | | and craters | | |
| 24 | Example 5 | Example 4 | Example 8 | Continuous corona | 48 | Good | 0/0 | 4.8 |
| 25 | Example 5 | Example 4 | Example 8 | None | 24 | Large holes | n.d. | n.d. |
| 26 | Example 5 | Example 4 | Example 8 | 1 × flame treatment, | 64 | Good | 0/0 | 8.0 |
| | | | | throughput 3 m/min | | | | |
| 27 | Example 5 | Example 4 | Example 8 | 2 × flame treatment, | 56 | Good | 0/0 | 3.4 |
| | | | | throughput 3 m/min | | | | |
| 28 | Example 3 | Example 2 | Example 9 | None | 33.7 | Holes and | n.d. | n.d. |
| | | | | | | craters | | |
| 29 | Example 3 | Example 2 | Example 9 | 1 × flame treatment, | 48 | Good | 0/0 | 2.3 |
| | | | | throughput 6 m/min | | | | |
| 30 | Example 3 | Example 2 | Example 9 | 2 × flame treatment, | 56 | Good | 0/0 | 1.4 |
| | | | | throughput 6 m/min | | | | |
| 31 | Example 5 | Example 4 | Example 9 | None | 27 | Poor, | n.d. | n.d. |
| | | | | | | repellent effect | | |
| 32 | Example 5 | Example 4 | Example 9 | 1 × flame treatment, | 48 | Very good | 0/0 | 2.6 |
| | | | | throughput 6 m/min | | | | |
| 33 | Example 5 | Example 4 | Example 9 | 2 × flame treatment, | 56 | Very good | 0/0 | 2.2 |
| | | | | throughput 6 m/min | | | | |

TABLE 2

| | Scratch- | | | Surface | | | Taber |
|---|---|---|---|---|---|---|---|
| Example | resistant | | | tension | | Cross- | 1000 |
| no. | sheet | Topcoat T | Activation | mN/m | Wetting | cut | cycles |
| 34 | Lexan | Example 9 | None | 27 | Poor, | n.d. | n.d. |
| | Margard | | | | repellent | | |
| | MR5E | | | | effect | | |
| 35 | Lexan | Example 9 | 1 × flame treatment, | 48 | Very good | 0/0 | 7.9 |
| | Margard | | throughput 6 m/min | | | | |
| | MR5E | | | | | | |
| 36 | Lexan | Example 9 | 2 × flame treatment, | 56 | Very good | 0/0 | 4 |
| | Margard | | throughput 6 m/min | | | | |
| | MR5E | | | | | | |
| 37 | Lexan | Example 8 | None | 24 | Many holes | n.d. | n.d. |
| | Margard | | | | and craters | | |
| | MR5E | | | | | | |
| 38 | Lexan | Example 8 | Continuous corona | 48 | Good | 0/0 | 7.5 |
| | Margard | | | | | | |
| | MR5E | | | | | | |

Lexan Margard MR5E is a transparent UV-resistant and abrasion-resistant material for plane glazing applications
supplied by General Electric Plastics GmbH, Rüsselheim. The sheet has a ual-coated surface.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for preparing a multilayered coated article comprising:
(a) providing a substrate (S);
(b) forming a scratch-resistant layer (R) having a surface, by applying a scratch-resistant coating composition onto said substrate, and partially curing the applied scratch-resistant coating composition, said scratch-resistant coating composition comprising a polycondensate prepared from at least one silane, said polycondensate being prepared by a sol-gel process;
(c) treating the surface of the scratch-resistant layer (R) by at least one of flame treatment, corona treatment and plasma treatment, thereby forming a surface-treated scratch-resistant layer; and
(d) forming a topcoat layer by applying a topcoat coating composition onto the surface-treated scratch-resistant layer, and curing the applied topcoat coating composition, said topcoat coating composition comprising a solvent and at least one silane,
wherein said scratch-resistant layer is interposed between said substrate and said topcoat layer.

2. The process of claim 1 wherein the polycondensate of the scratch-resistant coating composition is prepared from methylsilane.

3. The process of claim 1 wherein the polycondensate of the scratch-resistant coating composition is prepared from a composition comprising 10 to 70 wt. % silica sol, and 30 to 90 wt. % of a partially condensed organoalkoxysilane, in a solvent mixture comprising an aqueous solvent and an organic solvent.

4. The process of claim 1 wherein the polycondensate of the scratch-resistant coating composition is prepared from a composition comprising a silane having an epoxy group on at least one non-hydrolysable substituent, and optionally in the presence of at least one of particles and a curing catalyst selected from at least one of Lewis bases, alcoholates of titanium, alcoholates zirconium and alcoholates aluminium.

5. The process of claim 1 wherein the polycondensate of the scratch-resistant coating composition is prepared from at least one silyl acrylate

6. The process of claim 1 wherein the scratch-resistant coating composition further comprises methacryloxypropyltrimethoxysilane and AlO(OH) nanoparticles.

7. The process of claim 1 wherein the polycondensate of the scratch-resistant coating composition is prepared from at least one multifunctional cyclic organosiloxane.

8. The process of claim 1 wherein the surface treatment step is performed after complete curing of the scratch-resistant layer.

9. The process of claim 1 wherein the surface treatment step is conducted in one of a flame plant, a corona plant and a plasma plant.

10. The process of claim 1 wherein the surface-treated scratch-resistant layer and the topcoat layer have an adhesion energy of >70 mJ/m².

11. The process of claim 1 wherein the surface treatment step is performed in a continuous flame treatment plant at a throughput rate of 1 to 20 m/min.

12. The process of claim 1 wherein the surface treatment step is performed in a continuous corona plant under conditions of at least one of a throughput rate of 1 to 20 m/min, and a power of 500 to 4000 W.

13. The process of claim 1 wherein the surface treatment step is performed in a plasma chamber under a pressure of 1 to 10⁻² mbar, and at a power of 200 to 4000 W, in the presence of a process gas.

14. The process of claim 1 wherein the substrate comprises a plastic.

15. The process of claim 1 wherein the scratch-resistant layer has a thickness of 0.5 to 30 μm.

16. The process of claim 1 wherein the topcoat layer has a thickness of 0.1 to 3.0 μm.

17. The process of claim 1 further comprising:
forming a primer layer by applying a primer coating composition to said substrate; and
forming said scratch-resistant layer by applying said scratch-resistant coating composition to said primer layer,
wherein said primer layer is interposed between said substrate and said scratch-resistant layer, and said scratch-resistant layer is interposed between said primer layer and said topcoat layer.

18. The process of claim 1 further comprising,
drying the scratch-resistant coating layer prior to partial curing, at a temperature of at least 20° C., by exposing the scratch-resistant coating layer to at least one of convection and radiation.

19. The process of claim 1 wherein the scratch-resistant coating composition comprises at least one flow control agent, which is present in an amount of 0.03 to 1.0 wt. %.

20. The process of claim 1 wherein the topcoat coating composition comprises a polycondensate that is prepared from at least one silane, and optionally nanoscale inorganic solid particles which have polycondensable surface groups.

21. The process of claim 1 wherein the topcoat layer, after curing, has a haze of less than 10% after 1000 cycles of Taber abrasion testing.

22. The process of claim 1 wherein the topcoat coating composition comprises a solvent selected from at least one of water and alcohol.

23. The process of claim 1 wherein the topcoat coating composition is prepared by hydrolyzing,
(a) at lest one compound represented by general formula I,
M(R′)ₘ (I)
wherein M is an element selected from the group consisting of Si, Ti, Zr, Sn, Ce, Al, B, VO, In and Zn, R′ represents a hydrolysable radical, and m is an integer from 2 to 4; and
(b) optionally at least one compound represented by general formula II,
R_{b}SiR′ₐ, (II)
wherein the radicals R′ and R are the same or different, R′ is as defined above, R represents a group selected from an alkyl group, an alkenyl group, an aryl group, a hydrocarbon group with at least one halogen group, an epoxide group, a glycidyloxy group, an amino group, a mercapto group, a methacryloxy group and a cyano group, and a and b independently of one another have a value from 1 to 3, provided that the sum of a and b is four,
wherein the hydrolysis occurs in the presence of at least 0.6 moles of water for every mole of hydrolysable radical R′.

24. The process of claim 23 wherein the compound of formula II is present in an amount of less than 0.7 moles, relative to 1 mole of the compound of formula I.

25. The process of claim 23 wherein the compound of formula I is selected from at least one tetraalkoxysilane.

26. The process of claim 23 wherein the compound of formula II is selected from at least one of glycidyloxypropyl trialkoxysilane, methyl trialkoxysilane and methacryloxypropyl trialkoxysilane.

27. The process of claim 23 wherein said topcoat coating composition has a solids content of 0.2 to 10 wt. %.

28. The process of claim 23 wherein said topcoat coating composition further comprises at least one flow control agent which is present in an amount of 0.1 to 50 wt. %, based on total solids of the topcoat coating composition.

29. The process of claim 23 wherein the topcoat coating composition has a viscosity of 1 to 200 mPas.

30. The process of claim 23 wherein the topcoat coating composition is applied at a relative humidity of 50 to 75%.

31. The multilayered coated article prepared by the process of claim 1.
